(19) United States
(12) Patent Application Publication
(10) Pub. No.: US 2001/0056402 A1
(43) Pub. Date: Dec. 27, 2001

(54) Method and system for accessing financial information using wireless devices

(76) Inventors: Arun Ahuja, Thousand Oaks, CA (US); Peter Tompkins, Malibu, CA (US); Alan Young, New Canaan, CT (US); Grigor Markarian, Agoura, CA (US); Ram Vaidyanathan, Thousand Oaks, CA (US); Anand Tata, Moorpark, CA (US); Joe Pan, Rowland Heights, CA (US)

Correspondence Address: George T. Marcou, KILPATRICK STOCKTON LLP, Suite 800, 700 - 13th Street, N.W., Washigton, DC, 20005, US

(21) Appl. No.: 09/759,259

(22) Filed: Jan. 16, 2001

Related U.S. Application Data
(60) Provisional application No. 60/175,967, filed on Jan. 13, 2000.

(51) Int. Cl. G06F 17/60

(52) U.S. Cl. 705/43

(57) ABSTRACT

The present invention relates to a system and method for accessing financial information or conducting financial transactions and, more particularly, to an improved system and method for accessing financial information or conducting financial transactions using wireless communications devices, such as cellular telephones, personal digital assistants, and other web-enabled wireless devices.

### PRIORITY DATA

This application claims priority to U.S. provisional application No. 60/175,967 filed on Jan. 13, 2000 entitled “System and Method for Accessing Financial Information Using Wireless Devices” the disclosure of which is herein incorporated by reference.

### BACKGROUND OF THE INVENTION

1. Field of the Invention

The present invention relates to a system and method for accessing financial information or conducting financial transactions and, more particularly, to an improved system and method for accessing financial information or conducting financial transactions using wireless communications devices, such as cellular telephones, personal digital assistants, and other web-enabled wireless devices.

2. Description of the Related Art

In recent years banking customers have increasingly become accustomed to using automatic teller machine devices (ATMs). These have been relatively successful because they provide a simple and clear “menu” of choices to the customer at each step of each transaction, such that the customer is very readily led through the sequence of inputs required by the system to respond to the customer's request. it would be desirable if such functions could also be carried out by the consumer at remote locations (i.e., at locations other than the bank or the ATM machines), thus rendering the service more convenient and more likely to be commonly used.

Developments in communications technology in the past decade have made it possible for consumers to access information stored on large computer systems through microcomputers. It is well known that a home computer system can be used to communicate through standard telephone lines with large computer data bases storing such information as stock market statistics, airline flight schedules, and other useful consumer information. one way to allow customers to remotely access banking and other financial services is by providing access via a personal computer. To date, substantially all PC's have been configured to comprise a keyboard of between 60 and 101 keys, a display device, and a housing containing the circuit boards of the computer including various interfaces to other devices such as modems for communication, printers and the like.

Various firms, including AT&T and Sears, Roebuck & Co., have provided home banking services employing remote computer terminals which communicate with bank service computers. These have either involved “dumb terminals”, i.e., terminal devices having very little or no processing capability, or conventional PC's. Nether system allows for the customer to access financial information or conduct financial transactions from any location. Rather the customer must access the financial information or conduct financial transactions for the location of the computer terminal.

Recently, conventional systems have sought to use alternate telecommunication means for accessing financial information or conducting financial transactions. For exanple, U.S. Pat. No. 5,008,927 discloses generally a telephone-resembling device which performs computer functions as well as conventional telephone functions. These microprocessor/telephone communication devices provide a means for bringing technologically based services into the typical customer's home. However, these systems only disclose connecting the customer's remote terminal, whether a telephone-like device or a conventional personal computer, to a standard telephone line via an RJ-11 telephone jack. This can be inconvenient for customers who would like access to banking services via a remote terminal without having to connect with a telephone line or from a location at which a telephone line is not accessible.

Some systems have sought to provide terminals using wireless communication for financial transactions. For example, U.S. Pat. No. 5,221,838 discloses a wireless terminal which can be used to transmit and receive data to/from a financial institution. The wireless terminal can be used to update account balances as well as perform various types of transactions. U.S. Pat. No. 5,038,284 discloses a system for processing transactions between opposing traders which employs a plurality of portable transaction stations. The portable transaction stations can perform such tasks as time stamping of transactions, calculation of profit/loss, and average cost and uses a radio frequency transceiver for communication. U.S. Pat. No. 5,060,152 discloses a portable computer terminal device which can be used to transmit/receive transaction data to/from a central unit. However, all of these wireless schemes require that both the remote terminal and the receiving terminal be equipped with wireless receivers and transmitters. For large scale computerized financial systems already connected to the telephone system, adding wireless transceivers in order to facilitate communication with wireless remote terminals could be costly and/or impractical. It is desirable, therefore, to provide a wireless remote terminal without having to modify the computerized financial system or systems to which the wireless terminal is to communicate. Further, none of these systems offers any degree of secure communication.

In addition, the Bank of America has a system for conducting banking transactions using the Palm Pilot Palm VII personal digital assistant. However, this system does not permit a customer to use a wireless device other than a Palm VII to conduct a financial transaction.

Thus, there remains a need for a system and method for accessing financial information or conducting financial transactions employing a variety of different wireless devices, such as a variety of cellular telephones, personal digital assistants, and other web-enabled wireless devices.

### BRIEF SUMMARY OF THE INVENTION

Accordingly, it is an object of the present invention to provide a more efficient system and method for accessing financial information using a variety of wireless devices.

It as another object of the present invention to provide a more efficient system and method for conducting financial transactions using a variety of wireless devices.

It is still another object of the present invention to provide a secure and private method for accessing financial information using a variety of wireless devices.

It is still another object of the present invention to provide a secure and private method for conducting financial transactions using a variety of wireless devices.

These objects, among others, have been achieved by means of the present invention, a system for conducting financial transactions using a network of the type connected to at least one financial institution that maintains an account for a specific customer includes a central computer, at least two different wireless remote data terminals including a customer input system and an alphanumeric display, the wireless data terminal being coupled to a cellular telephone communication channel, wherein the structure of the financial information or the data for conducting financial transactions is independent of the manner in which the information or data is presented on the wireless remote data terminal.

It is an object of the invention to meet these needs, and others, through a financial information and transaction system which utilizes wireless communication in connection with portable terminals. In this system, a terminal is connected to the financial institution via a wireless or cellular telephone hook-up. It is a feature of the invention that so-called “smart cards” are utilized to verify authorization for transactions, thereby minimizing potential security problems which could otherwise result from use of a mobile terminal. According to an alternate embodiment of the invention, a smart card is advantageously utilized not only for authorization, but also to maintain a secure record of available funds.

According to another embodiment of the invention, a portable transaction terminal is internally powered by, for example, rechargeable batteries. In an alternate embodiment, the terminal is powered by a standard ac power supply through a conventional outlet.

In yet another embodiment of the invention, a cellular telephone, having a smart card reader incorporated therein, is utilized as a data terminal for various financial transactions.

According to a further embodiment, the system not only provides the functionality of an ATM network, but also provides non-financial services thereby forming an integrated system.

The above, and other objects, features and advantages of the present invention will become readily apparent from the following detailed description thereof which is to be read in connection with the accompanying drawings.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 presents three different embodiments of the present invention;

FIG. 2 provides a block diagram illustrating an embodiment of the present invention;

FIG. 3 illustrates the security aspects of an embodiment of the present invention;

FIG. 4 is a block diagram of a financial information and transaction system in accordance with the invention;

FIG. 5A is a block diagram of a first application of the invention which includes a wireless transmitting/receiving station;

FIG. 5B is a block diagram showing a second application of the invention which includes a wireless transmission/receiving station;

FIG. 5C is a perspective view of a cellular telephone terminal in accordance with the invention;

FIG. 6A is a perspective/block view of a first portable wireless transaction and information terminal in accordance with the invention;

FIG. 6B is a perspective/block view of a second portable wireless transaction and information terminal in accordance with the invention;

FIG. 7 is a block diagram of a wireless transaction and information system in accordance with the invention;

FIG. 8 is a block diagram of a smart card according to the invention; and

FIG. 9 is a block diagram of a file structure of the smart card of FIG. 8.

### DETAILED DESCRIPTION OF THE INVENTION

Other features of the invention will become apparent in the course of the following description of exemplary embodiments which are given for illustration of the invention and are not intended to be limiting thereof.

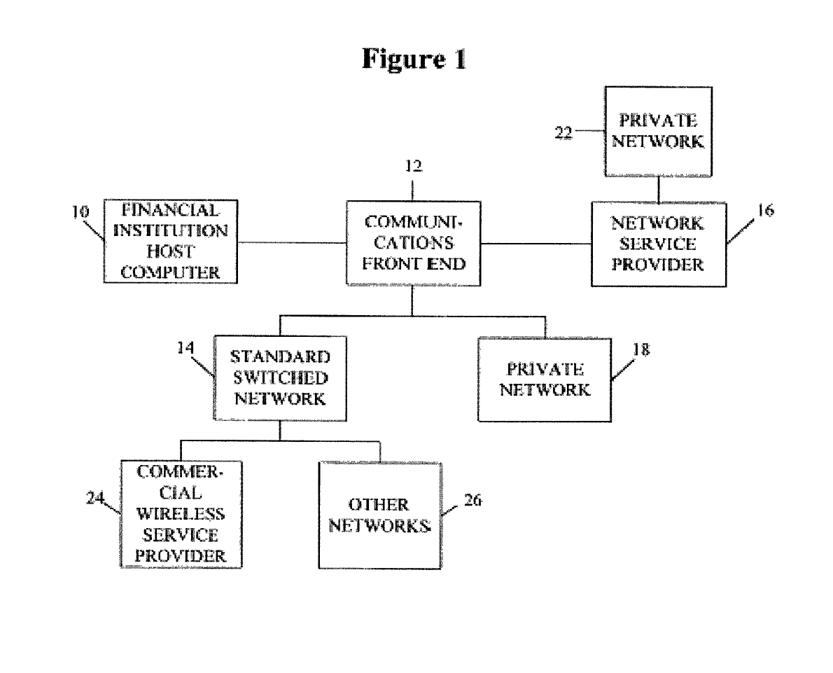

In FIG. 1, three different embodiments of the invention are presented. All three embodiments employ wireless devices such as cellular telephones and communicate through a mobile telecommunications network. However, the embodiments differ as to the communication mode.

The proliferation of automated teller machines (ATMs) has revolutionized the banking and financial services industry by increasing the ability to provide financial services to the consumer. For example, in the past virtually all consumer transactions were conducted in person. Thus, consumer access was generally limited to the business hours of branch locations. With the advent of ATM and other financial networks, consumers may now access financial services virtually twenty-four hours a day, seven days a week. This results in increased convenience and efficiency both for the service provider and the consumer.

Despite these successes, ATM and other financial networks in use today are characterized by certain shortcomings which limit consumer access and provide a barrier to more widespread accessibility and use. For example, the ATMs in greatest use today are hard wired in a fixed location. This hard wiring is necessary to provide power for the terminal and to provide access to communication lines, such as telephone lines, over which data may be exchanged with the financial service provider. Security concerns also play a role in limiting ATMs to fixed locations.

As a result of the fixed location of such terminals, financial networks must take great care in distributing ATMs over a particular geographic region so as to maximize consumer access. However, with changing demographics, such distributions may become less advantageous. For example, a new shopping mall may open in a first location, increasing demand in that area, while another mall may close in a second location thereby decreasing demand in that location. One-time or isolated events resulting in an unexpected influx of people to a particular area may also result in an overwhelming demand which cannot be met satisfactorily by an existing distribution of terminals.

Currently, such problems may be addressed by providing additional ATM terminals. However, the capital costs of such terminals and the necessary peripheral equipment, such as power supplies, maintenance facilities and so forth may be too prohibitive to permit adaptive response to the above-described changes in consumer demand.

Accordingly, there is a need for a financial transaction and information system which can overcome the aforementioned shortcomings. Specifically, there is a need to provide transaction and information terminals which can be conveniently repositioned by the operator as necessary to maximize availability and use of the financial services provided thereby. Further, there is a need for transaction and information terminals which do not need to be directly connected by lines to a telephone network or power source network.

There is an additional need to provide the above-described features without compromising the security provided by existing systems and without introducing inordinate costs.

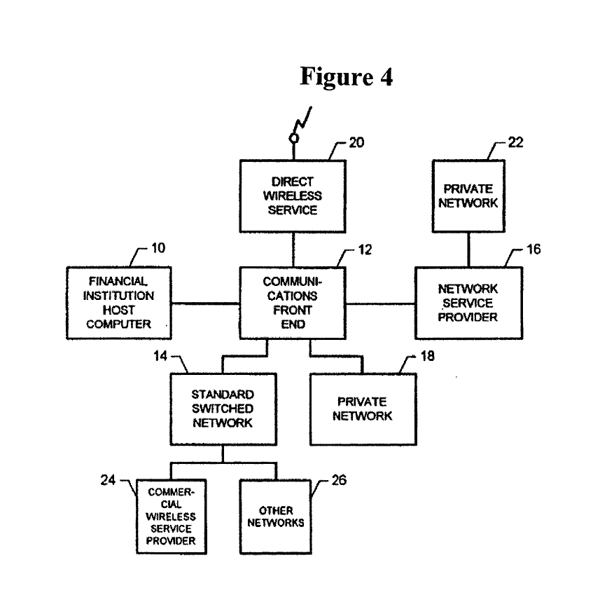

FIG. 4 is a block diagram illustrating a system for providing financial information and performing financial transactions in accordance with the present invention. In this embodiment, a financial institution is represented by block 10. As known in the art, the financial institution, such as a consumer banking institution, utilizes an automated system, including a host computer, for maintaining records of customer accounts. These records are used to keep track of funds in the customer accounts, to enter debits and credits made to such accounts, and for other purposes.

In order to provide various services to the customer, such as providing account information and account debiting and crediting at the customer's request, a communications front end 12 is used to exchange data corresponding to such information. The communication front end 12 provides access to the host computer operated by the financial institution 10 from a variety of communication systems. For example, as shown, the communications front end 12 may exchange data with a standard switch network 14, such as one operated by a regional telephone company. Thus, data transfer utilizing such a system generally takes place over the telephone line. In this way, data may be exchanged with a user suitably linked to the standard switch network 14 with a modem using any of a variety of communication protocols known in the art. Moreover, data may be exchanged in this way other financial institutions and financial networks (not shown), for example, to provide data for settlement of various customer transactions.

Alternately, the communication front end 12 may be connected to a network service provider 16 or a private network 18. For example, one of several commercial services now available may link users throughout a geographic area. Further, the communications front end 12 may provide an interface between the financial institution 10 and a private is network 18 comprising, for example, one or more local area networks (LAN) or wide area networks (WAN).

Further, the communications front end in this representation is connected to a direct wireless service 20. For example, such a hook-up could operate at a very high frequency (900 megahertz) along a cellular telephone-type or spread spectrum type connection (900 megahertz with multiplexers) for security purposes. The signal from the direct wireless service 20 may be received by a number of different types of terminals, described below.

As illustrated, FIG. 4 shows direct links between the communications front end 12 and the various types of communication systems 14, 16, 18, and 20. However, it will be understood by those skilled in the art that various combinations of such systems, and others, are possible. For example, a private network 22 may be accessed with the communications front end 12 through a network service provider 16. Alternatively, rather than the direct wireless communication represented by block 20, wireless communication may take place using various commercial wireless service providers 24 via the standard switch network 14. Other networks 26, such as the so-called “Internet,” may be accessed with the standard switch networks 14.

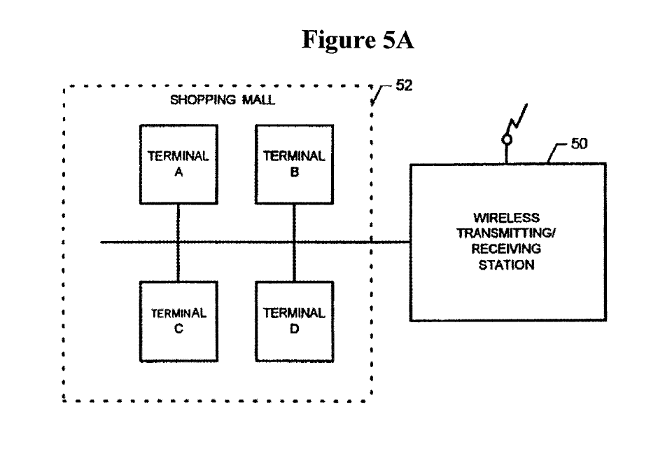

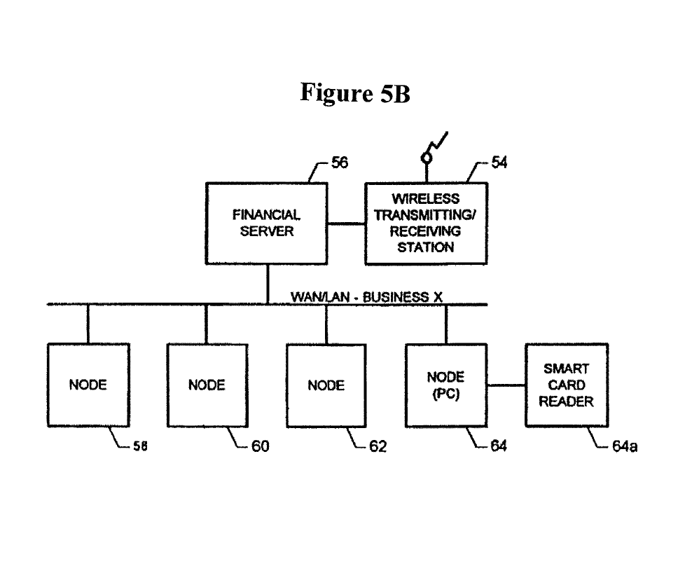

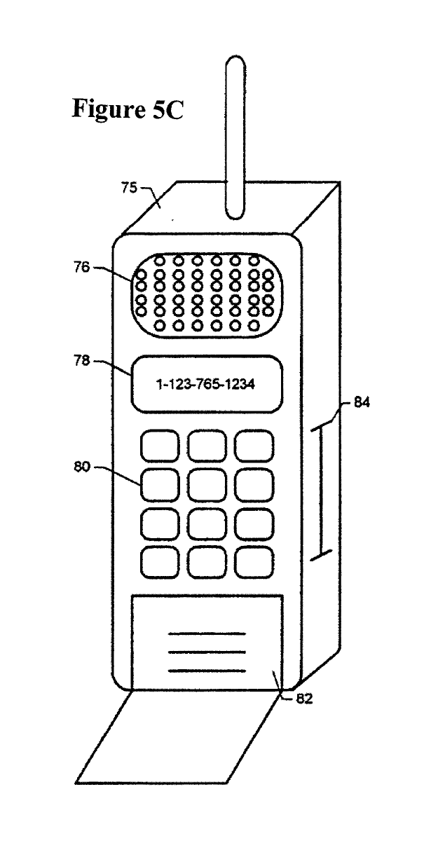

FIGS. 5A to 5C illustrate various applications in which wireless data transmission may be utilized to provide convenient access to a financial institution, such as the financial institution 10 mentioned above in relation to FIG. 4. For example, FIG. 5A illustrates an application in which a wireless transmitting and receiving station 50 is operatively linked to various terminals A to D distributed in a shopping mall 52 or other localized area.

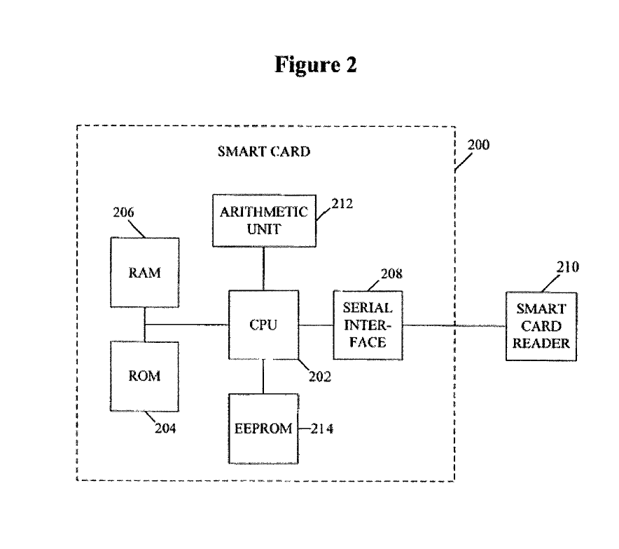

In FIG. 5B, a wireless transmitting and receiving station 54 is operatively linked to a financial server 56 associated with LAN or WAN of a business. Various nodes 58, 60, and 64 are provided along the network of the business. One such node 64 shown in FIG. 2B may comprise a personal computer which includes a smart card reader 64a.

In FIG. 5C a cellular telephone 75 serves as a financial information and transaction terminal. In this embodiment, the cellular telephone 75 includes standard features such as an alpha-numerical keypad 80, a speaker portion 76, a microphone portion 82, and a display 78 (for example, a LCD display). Additionally, a smart card reader portion 84 is provided. This additional feature provides the additional capability to perform financial transactions using the keypad 80 as an interface. The functionality of this embodiment and of those described above is apparent from the ensuing description.

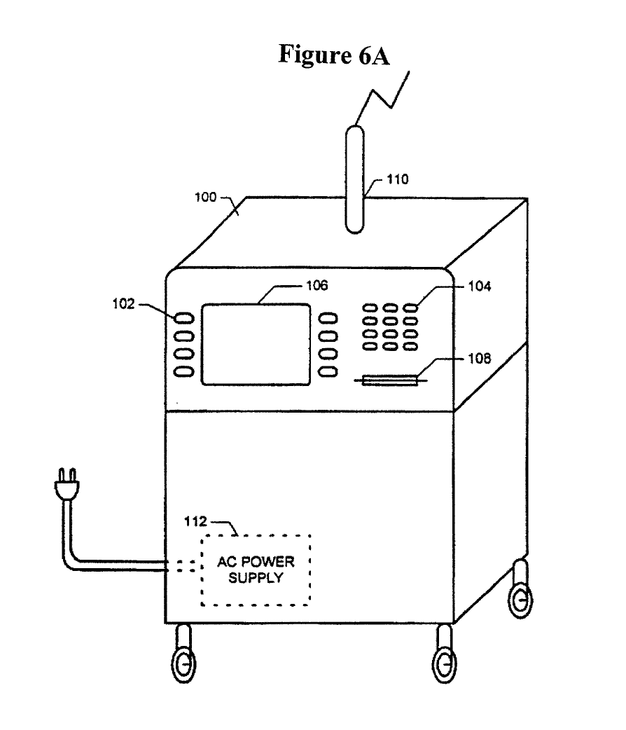

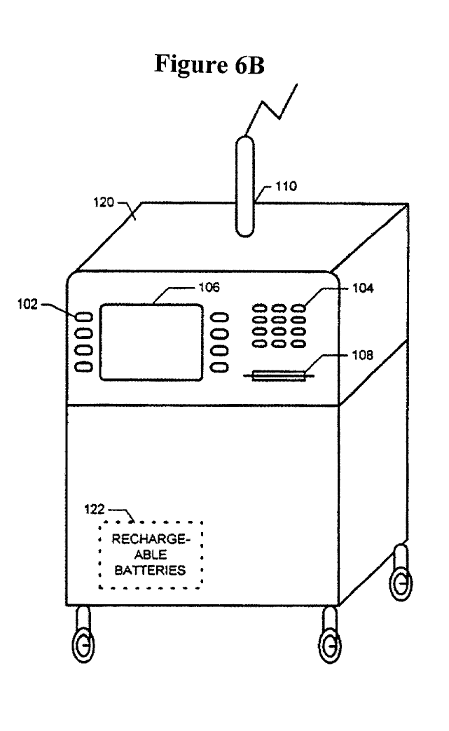

FIGS. 6A and 6B illustrate in greater detail embodiments of a portable, wireless terminal in accordance with the invention. In both of these embodiments and in those which are later described, use is made of a smart card anda smart card reader. As is known in the art, a smart card is a device which may include processing means as well as both volatile and non-volatile memory. Data stored in read-write memory on the smart card may be exchanged with a reader device, typically through a serial interface. One advantage of such use of the smart card is that encryption algorithms may be stored and processed with the smart card to allow the smart card to be validated from a remote location, for example, by a host computer operated by a financial institution. In this way, information can be securely exchanged between the card and the remote location using one or more encryption keys that are in place in both locations. The encryption keys are used to encode information to be transmitted and to decode information that is received.

Using encryption techniques, it is possible not only to encode financial information stored remotely by a host computer or locally on the smart card, but also to encode identification information, such as personal identification numbers (PINs). In this way a user's PIN may be encrypted by the smart card and communicated to a remote host which has the same encryption key to decode the encrypted PIN and to validate it. This provides authorization to access information stored by the host and/or to request various financial transactions.

FIG. 6A illustrates a first wireless terminal 100 for use with a smart card. This terminal 100 includes a customer interface 102, such as an alpha-numerical keypad 104, a display 106, and a smart card reader 108. Signals provided from a wireless service provider, such as one described in FIG. 1, are received by a transmitter/receiver portion 110 of the terminal 100. Conversely, signals are provided from the transmitter/receiver portion 110 of the terminal 100 to a front end processor via wireless service provider. In this manner, the terminal 100 may be used to wirelessly receive and transmit data to and from a financial institution or financial network. This data may then be read and write from and onto a smart card that is inserted into the smart card reader 108.

In this embodiment, the terminal 100 may be advantageously used to read data stored on a smart card to determine, for example, a value corresponding to an amount of funds existing in the user's account. With the terminal 100, the user may add to the amount stored on the card and have the added amount debited from the user's account by the host computer. In such a way, the terminal thereby functions as a credit-authorization terminal. The authorization and financial information is kept secure during transmission as a result of the encryption capabilities of a smart card that is used to access the terminal 100.

For example, the user may insert a smart card into the smart card reader 108. The card first encrypts, then transmits to the terminal 100 information stored on a smart card. This information identifies the financial institution which maintains the user's account as well as the user's account number. Additional security may be obtained by requiring that the user input a PIN with the numeric keypad. Again, the smart card can then encrypt the PIN for transmission by the terminal to a host computer for verification.

Once authorization has been obtained, the user may determine the user's current account balance and/or request that value be added to the card. In executing these requests, the terminal exchanges encoded information by wireless transmission with a financial network, such as one described above with respect to FIG. 4. For example, the terminal may be used to directly add value to the user's card, and then request by wireless transmission that the customer's account be debited a corresponding amount. These requests comprise encoded data which is decoded by the host computer associated with financial institution.

When the funds are transferred to and from the smart card, an encrypted bank signature appended to the funds certifies that the funds are “real.” It also ensures that when the transaction enters the settlement system, the funds are validated. Because the settlement system may involve more than one financial institution, when the transaction is ultimately presented to the financial institution for payment, the encrypted bank signature verifies that the transaction is authentic.

In the embodiment shown in FIG. 6A, the terminal 100 may operate with a standard ac supply 112 from a conventional outlet. In the embodiment of FIG. 6B (in which identical reference numerals are used to refer to corresponding structure described in reference to FIG. 6A), a terminal 120 is powered by rechargeable batteries 122 in order to provide even greater mobility.

It will be appreciated that such a terminal as described in reference to FIGS. 6A and 6B permits the user to conduct numerous financial transactions without a hard wired connection between the terminal and the financial institution. For example, the terminal can be used to “recharge” a smart card in the manner described above. After “recharging,” the user may then use the card in connection with terminals that accept this “electronic cash” in lieu of cash by deducting an amount from the user's card. The amount deducted can then be redeemed by a merchant through a settlement process with the user's financial institution (and others).

It can be seen that the terminal described in FIGS. 6A and 6B is a truly mobile unit and enjoys the benefits of such mobility. Because the terminal is not required to dispense cash, no safe is required. This, in turn, reduces the cost and size of the terminal and maximizes the flexibility of the design of the terminal. For example, the terminal may be positioned in the corridor of a mall or an office building, thereby maximizing its access and availability to foot traffic during the day. At night, the terminal could be rolled back in from the corridor and accessed for settlement/verification procedures in accordance with standard industry practice with ATMs. In the embodiment of FIG. 6B, the terminal's batteries could be recharged during this time for use the next day.

Alternatively, the mobile terminal could be positioned on a truck which could be parked outside at a fair or sporting event and powered by batteries or a generator stored on the truck. Again, the mobile terminal is positioned to maximize access to foot traffic and is repositioned at night for recharging, servicing, etc. Positioned in this way, the above-described terminals provide increased flexibility and adaptiveness for responding to customer demands.

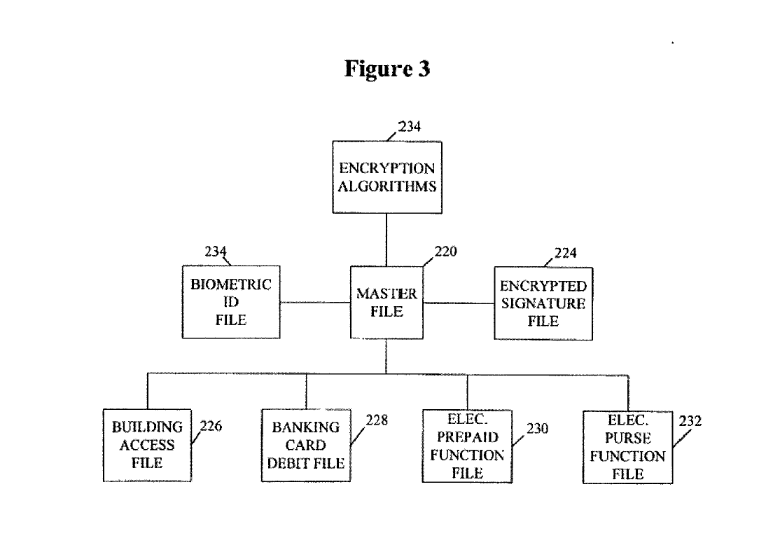

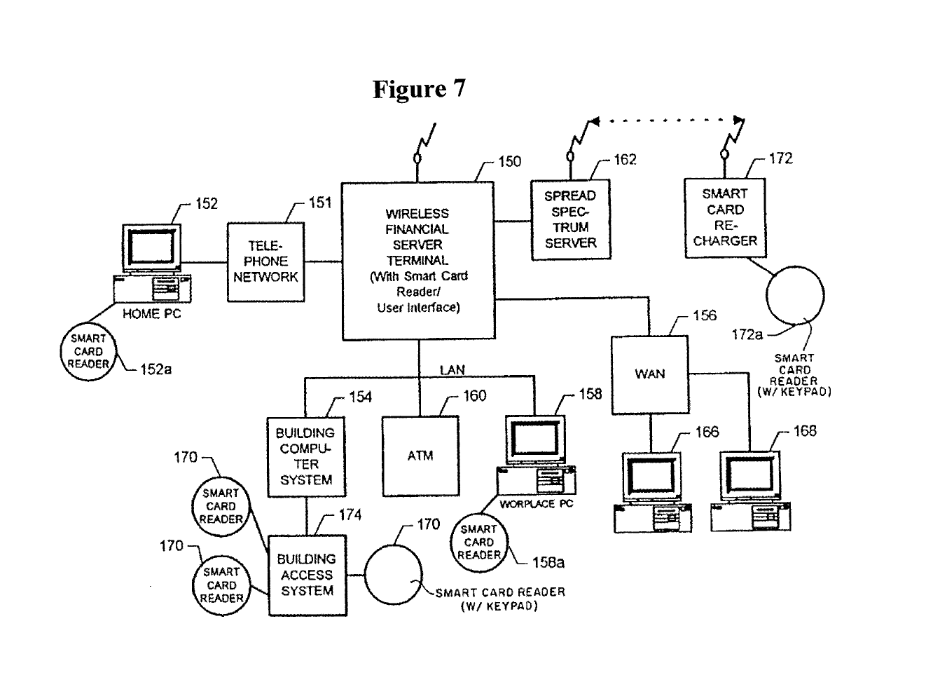

FIG. 7 illustrates another embodiment of the invention in which a wireless server/terminal unit 150 is used to exchange financial information between a user and a remote host computer of a financial institution, such as that referred to in FIG. 4. The wireless server/terminal unit 150 preferably includes a terminal described above in reference to FIGS. 3A and 3B (that is, one which incorporates a display, a keypad, a smart card reader, and means for wireless transmission of data).

The system shown in FIG. 7 integrates the capability of exchanging financial information with other non-financial functionality, such as security control. In particular, the wireless server/terminal unit 150 forms a portion of a LAN which comprises a variety of other computers and networks. As illustrated, these other computers and networks include an employee's work place PC 158, an employee's home PC 152, a WAN 156, a local building computer system 154, a conventional ATM 160, and a spread spectrum server 162.

A variety of terminals and associate device are coupled to the networks shown. For example, the WAN 156 includes PCs 166 and 168. A building access system 174 includes various smart card readers 170, some of which are equipped with keypads. Similarly, each of the employee PCs 152 and 158 are equipped with smart card readers 152a and 158a.

Also, a plurality of terminals, represented by the terminal 172, are coupled to the spread spectrum server 162. For example, the terminal 172 is equipped with a smart card reader 172a. In this way, the wireless financial server terminal 150 enables employees to access their financial institution through a variety of means and from a variety of locations in the work place and at home.

In particular, the wireless smart card recharge station 172 communicates to the financial institution via the spread spectrum receiver 162 and the server terminal 150. The recharge station 172 has a slot for receiving and reading a smart card and a display (see FIGS. 6A and 6B). Through its connection with a financial system, such as that shown in FIG. 4, the user makes selections from a menu displayed on the display of the terminal 172. For example, the user may review account balances, transfer funds, or perform other activities typically available on a fixed-location ATM. The user may also reload monetary value onto the smart card via the cash station, adding set funds to either a “prepaid” or “purse” account on the smart card as described below. In this way the user can obtain access to money via a portable ATM-type terminal without security risk because no cash is directly involved. At the end of the user's visit to a location where the smart card is honored, the user may employ the station to deposit any unused balances from the user's smart card to the user's account with the financial institution.

As shown, a user's PC 152 may be connected to a smart card reader, such as one having a keypad and processing capabilities. This enables the user to access the user's financial accounts and to “recharge” the smart card (that is, add funds onto the smart card). In this respect, the keypad enables the user to enter the user's PIN and the smart card inserted into reader 152a provides additional encryption and security measures to make the transport route (namely, the LAN/wireless terminal/route) sufficiently secure to conduct financial transactions. A similar arrangement is conducted at other remote locations through a telephone line connection between the terminal and the employee's home personal computer connected to a smart card reader/processor and keypad. Further, a smart card reader/processor with a display which simulates an ATM protocol could be connected to the terminal, thereby enabling the user to perform all ATM functions including recharging the smart card, without the use of a personal computer.

Thus, the server terminal 150 provides a communications channel for several remote devices, such as the home PC 152, the work place PC 158 and the terminals 172 associated with the spread spectrum server 162 and those associated with the wide area network 156. By providing card readers with these terminals, it is possible to obtain a wide range of access points to a remote host computer via the wireless financial server/terminal. This provides additional capabilities to the above-described financial information and transactions.

Additionally, the embodiment of FIG. 7 describes an integrated system which may be used for other non-financial transactions. For example, the building computer system 154 noted above may be used to control a building access system 174. The building access system of this example includes a plurality of smart card readers and/or keypads. Such interface devices may be used to verify that a user is authorized to enter particular areas by matching information stored on a smart card against security records maintained or updated through the server/terminal unit 150. Different security levels may be instituted for different areas, each requiring additional authorization. For example, it may only be necessary to insert a card to access a parking garage, while gaining access to particular rooms may require additional authorization, for example, the inputting of a PIN with a keypad.

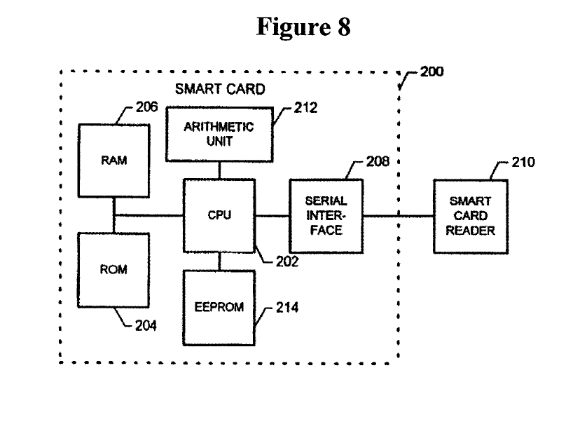

FIG. 8 illustrates a multi-purpose smart card 200 which permits both financial and non-financial functions in an integrated system such as that described in FIG. 7. The smart card 200 comprises a central processing unit 202 (CPU) which is connected to a read only memory 204 (ROM), primarily used for storage of an operating system. A random access memory 206 (RAM) is also provided for volatile storage of data, particularly for program execution. The CPU 202 is operatively coupled to a serial interface 208 which in turn communicates with a smart card reader 210 according to techniques well known in the art.

The CPU is connected to an arithmetic logic unit 212, for example, one suitable for processing large keys (512 byte keys). An electrically erasable programmable read only memory 214 (EEPROM) is provided, which typically stores system files and applications.

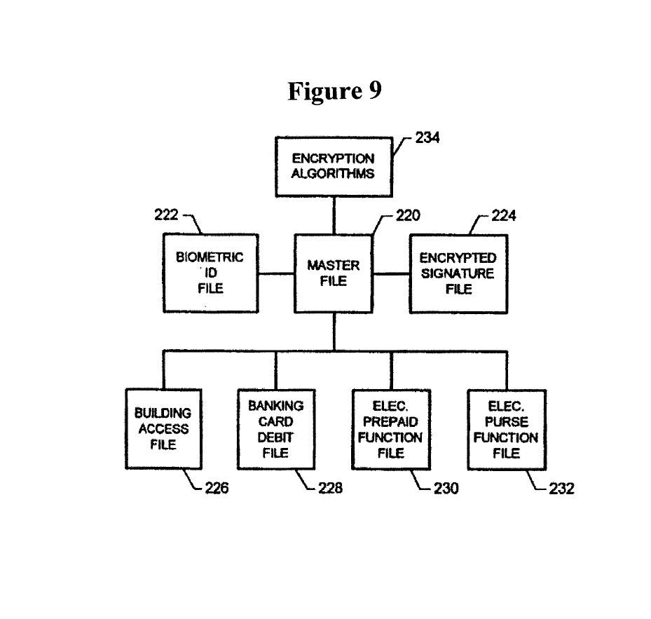

As illustrated in FIG. 9, the smart card 200 of FIG. 8 has different file paths for different functions. The EEPROM has a master file 220 and dedicated files for different applications. These dedicated files include a biometric identification file 222 and an encrypted digital signature file 224. Also included is a building access file 226 that contains information which enables the card to be used in conjunction with a security system, such as the one referred to in FIG. 7. The master file 220 also is linked to a banking card debit file 228 which may also have its own security path for identification. The smart card has a prepaid function path 230 which can only be loaded through a secure function, and a “non-secure” electronic purse function file 232. These files are readable by an external terminal, such as the terminal described in reference to FIGS. 6A and 6B, and may be decremented as required from an outside terminal, as described more fully below.

In this example, the master file 220 also has a digital encryption capability 234 providing algorithmic computation for the processing of digital keys and encryption of, for example, the user's PIN. The algorithms used may provide symmetrical or asymmetrical encryption as known in the art.

While the smart card utilized in the invention embodies a “computer”, it has a fairly limited memory. For example, the EEPROM may be limited to the range between 3 to 8 kilobytes with current technology limitations. Accordingly, the smart card in the system preferably acts as an enabling device for other systems according to known techniques. For example, the smart card provides validation of the individual and the service requested, but does not store large quantities of data on the card.

It should be understood from the above description that as the mobility of an ATM-type terminal increases, security concerns may also increase. More specifically, it may be unfeasible to place cash in a mobile ATM due to the possibility of theft of the terminal. Use of a smart card enables the system to provide users with secure purchasing in a cash-free environment.

Further addressing this concern, the smart card 200 of FIGS. 8 and 9 includes two storage areas for storing monetary values. The first is an “electronic purse” represented by file 232. This area is used, for example, when the user makes a high value purchase by placing the smart card in a merchant's terminal. The user accepts the transaction and amount of the purchase entered by the merchant by entering the user's PIN. The user then approves the amount, for example, by pushing an “enter” button on a terminal keypad, the card purse cash value is then debited by the requested amount, and, conversely, the merchant's account is credited that amount.

A second area for storing monetary values on the card comprises a “prepaid account” represented by file 230. This account is generally utilized for lower value purchases, for example, fifty dollars or less. This account is kept in an unsecured cash area of the smart card and operates essentially like cash. For example, the user of the smart card may make purchases from this account without entering the user's PIN. Possible uses would include, preferably, low value, fast transactions such as at a cafeteria, or a vending machine, or when placing a local telephone call.

The smart cards referred herein interface with the system through the use of various smart card reader/processors. These processors vary in complexity and sophistication depending upon the application. For example, when used to regulate building access, the smart card may be inserted into a smart card reader which simply identifies the user. This could be used in lower security areas, such as parking garages. A numerical keypad, by which a user's PIN may be entered, can be required for added security, such as at building door entrances. For even further security, some biometric parameter (such as a fingerprint) may be used for identification. This same access code with or without a PIN can be used in a smart card reader attached to a stand-alone or network personal computer 158A to control the level of access to local or remote files, communication networks, databases and network services.

In the aforementioned embodiments, the smart card incorporates optional digital encryption signatures and encryption algorithms to enable the smart card to be validated from a remote location, such as a host computer at a financial institution or at off/on line merchant terminals equipped with a SAM module for off-line card authentication. In such instances both ends of the communication (for example, the host computer and the smart card) may each have an encryption key so that data (such as a PIN entry) which is sent via the smart card 60 is validated at the host computer. Thus, the host computer is able to validate that the smart card is authentic and that the proper user is using the smart card so that a financial transaction can take place.

In a wireless off-line situation, the smart card and the terminal being used similarly validate one another because there is a possibility that a false terminal is being used. Accordingly, even in an off line system, security measures are available to validate the card, the terminal, and the user.

For example, in one preferred embodiment of the invention, the wireless terminals employ the global system for mobile telecommunications (GSM) network. In another embodiment of the invention, the wireless terminals utilize the GSM network and the subscriber information module application tool kit (SIMAT). In a third embodiment of the invention, the wireless device is a wireless application protocol (WAP) phone.

In each of these embodiments the wireless devices communicate by means of a mobile telecommunications network. In the GSM embodiments, this communication occurs by means of a small message system controller, a telecommunications system that permits text messaging and simple text page transmission from an access gateway. Alternatively, a WAP phone can use a WAP gateway to access the Internet.

The access gateway or Internet connection, in turn, is linked to the host computer of a financial institution. For example, in one embodiment of the invention, the gateway or Internet connection is linked to the network delivery system (NTDS) of a financial institution.

FIG. 2 illustrates a specific embodiment of the present invention, in which a wireless terminal, such as a cellular telephone, communicates over a mobile telecommunications network, for example, the I-Mode Network, with a mobile telecommunications server. This network in turn communicates with a server on the mobile banking server, which, in turn, is linked to the host computer of a financial institution.

FIG. 3 presents an overview of certain security aspects of the invention. In this preferred embodiment, a wireless terminal communicates over a wireless network with a mobile telecommunications server for the network. This portion of the system is secured by means of PKI encryption. The telecommunications network server, in turn, communicates with a mobile banking server linked to the host computer of a financial institution. One or more encryption devices can be placed on this transmission link. In addition, the link between the mobile banking server and the host computer of the financial institution can be protected by means of a firewall.

The present invention comprises a system for conducting financial transactions using a network of the type connected to at least one financial institution that maintains an account for a specific customer which includes a central computer, at least one wireless remote data terminal including a customer input system and an alphanumeric display, the wireless data terminal being coupled to a cellular telephone communication channel, the remote data terminal including a system for generating first data representing a payee, second, data representing an amount, and third data representing a network compatible personal identification number, a telecommunication system, the telecommunications system for communicating the first; second and third data from the wireless remote data terminal to the central computer via a wireless telecommunications network, the central computer further including a system for generating a digital message responsive to the communicated first, second and third data and for applying the digital message including the network compatible personal identification number to the network so as to selectively effect debiting of the customer account substantially in real-time response to customer manipulation of the wireless remote terminal input keys.

According further to the present invention, the terminal can include an alphanumeric display device capable is of displaying a maximum of N lines of text, N being an integer; and a plurality of keys manipulable by the customer, for selecting one of the N display lines. The central computer can connect to the cellular telephone communication channel via a packet data network that frames messages in packets of predetermined length. The central computer can include a system for generating display data specifying the display content of all of the lines of the display. The system can include an encryption system for encrypting at least the third data and/or the personal identification number.

The system can be configured such that the central computer generates a data packet comprising digital data representing display and prompt information and transmits the generated packet to the terminal via the cellular telephone communication channel. The terminal of the system can further include a help key and a cancel key and the central computer can include a system for providing help information for display on the terminal display in response to customer depression of the help key wherein the central computer ignores the last keystroke provided by the customer in response to depression of the cancel key. The terminal can further include an alphanumeric keypad for facilitating input by the customer of the second data screen navigation keys for requesting recall of information previously displayed by the terminal.

According further to the present invention, the remote data terminal can include a wireless terminal for connecting to the cellular telephone communication channel, the terminal providing voice and data communications capabilities, the terminal including a housing, a digital controller disposed within the housing, the customer input system being coupled to the digital controller for inputting the personal identification number, an encrypting system coupled to the digital controller and disposed within the housing for encrypting the inputted personal identification number to provide network compatible encrypted personal identification data wherein the alphanumeric display is electrically coupled to the digital controller and disposed on the housing, and the display panel is capable of simultaneously displaying a plurality N of discrete lines of information, a plurality of customer-manipulable controls, coupled to the controller and disposed on the housing, the controls for selection of menu options displayed on the display information lines, a telephone handset for permitting voice communications over the cellular telephone communication channel for communicating bidirectionally with the central computer in a packet data network format to efficiently provide a high degree of on line interactivity between the central computer and a customer viewing the display and operating the controls. The system can include a system for periodically transmitting a random number over the cellular telephone communication channel and can include a power supply for providing power to at least the controller. The controller can include a memory buffer for receiving and temporarily storing signals representing customer input and for supplying the stored signals for transmission over the cellular telephone communication channel. The terminal can further include navigational keys for requesting display of previous and subsequent screens in a predetermined sequence of screens. The system can include a system for interfacing with a non-volatile memory element so as to permit credits to be downloaded to the terminal and stored by the memory element.

According further to the present invention, a method of distributing financial services remotely, includes the steps of providing a plurality of wireless remote banking terminals to a corresponding plurality of customers, receiving bill paying requests including customer-supplied network compatible personal identification information from the plurality of terminals over cellular telephone communication channels, and processing the bill paying requests substantially in real-time at a central computer operatively coupled to the cellular telephone communication channels, the processing step including generating POS or other ATM interchange-compatible debit messages including the network compatible personal identification information responsive to information transmitted by customers from the wireless remote banking terminals to the central computer over the cellular telephone communication channels, transmitting the debit messages over a network substantially in real-time response to customer bill paying requests, debiting the customer's bank accounts substantially in real-time in response to the debit message, and paying entities selected by the customers via the wireless remote banking terminals with funds obtained by debiting the customer's bank accounts. The bill paying requests receiving step can include the step of receiving a customer-inputted personal identification number that is encrypted.

According further to the present invention, a method of paying bills includes the steps of activating a microprocessor-based wireless remote banking terminal coupled to a cellular telephone communication channel, causing and controlling the wireless remote banking terminal to establish communications with a central computer over the cellular telephone communication channel, inputting a PIN customer identification number, manipulating the terminal to select a payee, manipulating the terminal to select an amount to pay the payee, encrypting the PIN customer identification number at the wireless remote banking terminal to provide a network compatible encrypted PIN customer identification number, transmitting data representing the network compatible encrypted PIN customer identification number and the amount from the wireless remote banking terminal to the central computer, generating, substantially in real-time at the central computer in response to the transmitted data, a network transaction debit message encoding at least the network compatible encrypted PIN and the amount, transmitting the network transaction debit message from the central computer to the customer's bank substantially in real-time over a network, validating and processing the network transaction debit message substantially in real-time, controlling, with the central computer, a system for paying the selected payee the selected amount, and transferring funds in the amount specified by the network transaction debit message from the customer's bank to the operator associated with the central computer.

According further to the present invention, the wireless remote banking terminal can include an alphanumeric multiline display, and the manipulating steps each include the step of prompting for inputs by displaying information on the alphanumeric multiline display. The wireless remote banking terminal can include plural customer-depressible controls, and the inputting step can include the step of inputting the PIN customer number by depressing the controls. The encrypting step can include encrypting the PIN customer identification number.

According further to the present invention, a method of providing wireless remote banking services includes the steps of communicating, via one or more cellular telephone communication channels, with the wireless remote banking terminals on demand using a central computer, receiving financial service requests from the wireless remote banking terminals via the cellular telephone communication channels, the receiving step including receiving at least a network compatible encrypted customer PIN, an amount, and a payee selection,: processing the received financial service requests with the central computer, including the steps of generating and communicating messages from the central computer to a customer's banks over a network resulting in debiting of the customer's bank account electronically substantially in real-time response to receipt of customer bill paying requests, including the step of generating a digital network transaction message containing at least the network compatible encrypted customer PIN and the amount and applying the message to the network, disbursing payments electronically with the central computer to payees selected by the customers. The method can further include the step of separately communicating the payee selection to the customer's bank. The disbursing step can include the step of electronically disbursing the payments by communicating data across a network of electronic lockboxes. The method can further include encrypting customer PIN data within the wireless remote banking terminals.

According further to the present invention, a method of distributing financial services remotely, includes the steps of providing wireless remote banking terminals to customers, communicating, via cellular telephone communication channels, with the wireless remote banking terminals on demand using a central computer, receiving via the cellular telephone communication channels financial service requests including encrypted PIN information with the central computer from the wireless remote banking terminals, processing the received financial service requests with the central computer substantially in real-time including generating a debit request substantially in real-time response to receipt of the financial service requests.

According further to the present invention, a method of paying bills includes the steps of activating a microprocessor-based wireless remote banking terminal coupled to a cellular telephone communication channel, causing and controlling the wireless remote banking terminal to establish communications with a central computer over the cellular telephone communication channel, inputting a PIN customer identification number, manipulating the terminal to select a payee, manipulating the terminal to select an amount to pay the payee, encrypting the PIN within the wireless remote banking terminal to provide a network compatible encrypted PIN, transmitting data representing the network compatible encrypted PIN customer identification number, the selected payee, and the amount from the wireless remote banking terminal to the central computer via the cellular telephone communication channel, storing a plurality of recurring payment dates, parsing the stored payment dates and determining which of the stored payment dates, if any, correspond to the current date, if stored payment data corresponds to the current date, generating, substantially in real-time at the central computer in response to the stored data, a debit message specifying at least the network compatible encrypted PIN, the bank account selection, and the amount, and transmitting the network transaction debit message from the central computer to the customer's bank substantially in real-time over a standard network to effect a real-time debit of the customer's bank account.

According to the present invention, a method of delivering at least one electronic service to multiple customers at least in part via cellular telephone communication channels and home terminals, includes the steps of receiving, from a wireless remote terminal over the cellular telephone communication channels, an electronic service request and network compatible personal identification information associated with a customer, generating an network debit request message encoding the received network compatible personal identification information, applying the debit request message including the network compatible personal identification information to a network to effect a real-time debiting of funds from an account associated with the customer substantially in real-time response to receipt of the electronic service request from the customer, and repeating the above steps for multiple customers. The method can further include the step of providing extensive bidirectional interaction between the wireless remote terminal and a computer substantially in real-time via the cellular telephone communication channels so as to provide real-time online interactivity with the customer. The receiving step can include receiving a request for wireless remote banking services from the customer, receiving a request for electronic bill payment from the customer, receiving a request for wireless remote banking services from the customer, or receiving a request for electronic bill payment from the customer. The method according to the invention can further include supplying, to each of the multiple customers, the wireless remote terminal having a display. The method can further include the steps of encrypting the personal identification number, and transmitting the encrypted personal identification number over the cellular telephone communication channels for receipt by a remote computer in the receiving step.

The above-described systems allow a customer to have access to banking and financial services via a remote terminal without the need to connect to an RJ11 or other type of standard wired telephone connection. Furthermore, since the remote terminal takes advantage of cellular telephone technology, and since cellular telephone technology interfaces with the standard telephone system, then the remote terminals can be used in conjunction with large scale computerized financial systems that interface with the standard wired telephone system without having to add new communications capability to the large scale computerized financial systems.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

1. A financial information and transaction system comprising:
a host financial computer system, said host system maintaining records of user account information;
a plurality of user interface terminals for accessing said host financial computer system, at least one of said terminals comprising first means for wirelessly transmitting and receiving data, and a smart card reader;
a wireless communications interface comprising a second means for wirelessly transmitting and receiving data operatively counted to said at least one of said terminals comprising first means for wirelessly transmitting and receiving data; and
a communications interface coupled to said wireless communications interface and coupled to said host system;
wherein data corresponding to said user account information is exchanged between said host system and said at least one of said terminals comprising first means for wirelessly transmitting and receiving data via said wireless communications interface and said communications interface, such that a user obtains information and performs transactions on said host financial system through a smart card device that is coupled to said smart card reader, said smart card device including means for encrypting data which is exchanged with said host financial system.

2. The financial information and transaction system according to claim 1, wherein said communication means comprises means for transmitting and receiving data at a frequency of about 900 megahertz or more.

3. The financial information and transaction system according to claim 1, wherein said at least one terminal comprises a plurality of said terminals devices coupled to a common wireless transmitting and receiving station.

4. The financial information and transaction system according to claim 1, wherein said plurality of said terminals are arranged in a local area network.

5. The financial information and transaction system according to claim 1, wherein said at least one of said terminals comprises a wireless cellular telephone device.

6. The financial information and transaction system according to claim 5, wherein said wireless cellular telephone device includes a smart card reader incorporated therein.

7. The financial information and transaction system according to claim 1, wherein said at least one of said terminals comprises a portable terminal that includes a keypad and display.

8. The financial information and transaction system according to claim 7, wherein said portable terminal is supplied with ac power from a standard power supply.

9. The financial information and transaction system according to claim 7, wherein said portable terminal is battery operated.

10. The financial information and transaction system according to claim 4, wherein local area network includes a plurality of personal computers, each having smart card readers by which a user encrypts and decodes data which is exchanged with said host system.

11. The financial information and transaction system according to claim 1, wherein said at least one terminal is operatively coupled to a security system for controlling access to various physical locations each associated with a smart card reader, said security system providing access to said various locations by matching information stored on a user smart card which is inserted into said associated smart card readers.

12. The financial information and transaction system according to claim 1, wherein said smart card device includes a plurality of files stored therein.

13. The financial information and transaction system according to claim 12, wherein one of said plurality of files corresponds to an encryption key which is executed by processing means provided in said smart card device, thereby encrypting data provided to said smart card device.

14. The financial information and transaction system according to claim 12, wherein one of said plurality of files is a banking card debit file, said banking card debit file containing data elements for execution of a debiting of said user account.

15. The financial information and transaction system according to claim 12, wherein one of said plurality of files is an electronic prepaid function file, said electronic prepaid function file maintaining data elements representative of a monetary value which is augmented or decremented by said at least one of said terminals upon authorization by the user.

16. The financial information and transaction system according to claim 15, wherein said authorization is obtained by the user inputting a personal identification number associated with the user's account.

17. The financial information and transaction system according to claim 13, wherein one of said plurality of files is an electronic purse function file, said electronic purse function file maintaining data elements representative of a monetary value which is augmented or decremented by said at least one of said terminals.

18. The financial information and transaction system according to claim 1, wherein said at least one of said terminals is coupled to a security system for controlling access to various physical locations each associated with a smart card reader, wherein said smart card device includes at least one file containing data elements for providing authorization to access one or more of said physical locations.

19. The financial information and transaction system according to claim 18, wherein said smart card device includes a biometric identification file which contains identification data corresponding to unique physical characteristics of a user, said identification data being used to authorize access to one or more of said physical locations.

20. The financial information and transaction system according to claim 18, wherein said authorization to access said one or more physical locations is obtained by the user inputting a personal identification number associated with the user.

21. The financial information and transaction system according to claim 1, wherein said at least one of said terminals is coupled to a host system for controlling access to a communication network and wherein said smart card device includes at least one file containing data elements for providing authorization to access said communication network.

22. The financial information and transaction system according to claim 1, wherein said at least one of said terminal is coupled to a host system for controlling access to a network device and wherein said smart card device includes at least one file containing data elements for providing authorization to access said network service.

23. The financial information and transaction system according to claim 1, wherein said at least one of said terminals is coupled to a host system for controlling access to a data base and wherein said smart card device includes at least one file containing data elements for providing authorization to access said data base.

24. The financial institution and transaction system according to claim 21, wherein said smart card device includes a biometric identification file which contains identification data corresponding to unique physical characteristics of said user, said identification data being used to authorize access to said communication network.

25. The financial institution and transaction system according to claim 22, wherein said smart card device includes a biometric identification file which contains identification data corresponding to unique physical characteristics of said user, said identification data being used to authorize access to said network service.

26. The financial institution and transaction system according to claim 23, wherein said smart card device includes a biometric identification file which contains identification data corresponding to unique physical characteristics of said user, said identification data being used to authorize access to said data base.

27. The financial information and transaction system according to claim 21, wherein said authorization to access said communication network is obtained by the user inputting a personal identification number associated with the user.

28. The financial information and transaction system according to claim 22, wherein said authorization to access said network service is obtained by the user inputting a personal identification number associated with the user.

29. The financial information and transaction system according to claim 23, wherein said authorization to access said data base is obtained by the user inputting a personal identification number associated with the user.

30. The financial information and transaction system according to claim 1, wherein said plurality of terminals are arranged as part of a wide area network.

31. The financial information and transaction system according to claim 1, wherein said terminal comprises an automatic teller machine.
